(19) United States
(12) Patent Application Publication
(10) Pub. No.: US 2008/0084575 A1
(43) Pub. Date: Apr. 10, 2008

(54) System and method to remotely access multi-function peripheral (MFP) workflows

(76) Inventor: Nehal Dantwala, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/545,945

(22) Filed: Oct. 10, 2006

(51) Int. Cl. G06F 3/12

(52) U.S. Cl. 358/1.15; 358/402

(57) ABSTRACT

A system and method for remotely accessing a device having a scan capability are disclosed. In one aspect, the method comprises remotely connecting to the device via the embedded web server, traversing a remote control panel provided by the embedded web server, uploading an electronic document to the device via the remote control panel, and selecting a first control on the remote control panel to process the uploaded document. The front panel comprises a second control associated with a process for a scanned document. The first control corresponds to the second control so as to process the uploaded document according to the process associated with the second control.

### RELATED APPLICATIONS

This application is related to U.S. application Ser. No. ______ (Attorney Docket No.: SAMINF.032A), filed on the same day herewith and titled “SYSTEM AND METHOD TO REMOTELY CONTROL THE FRONT PANEL OF A MULTI-FUNCTION PERIPHERAL FROM AN EMBEDDED WEB SERVER,” which is hereby incorporated by reference.

### BACKGROUND OF THE INVENTION

1. Field of the Invention

The invention relates to a multi-function peripheral (MFP). More particularly, the invention relates to remote access and control of a MFP.

2. Description of the Related Technology

There exist workflows on many MFP devices today which are tied to the business processes. A workflow is used here to refer to highly specialized sequence of tasks. These tasks are typically associated with processing one or more documents. For example, an account payable workflow may be used to scan bills and send the same to accounts payable. An account payable workflow could be as follows: a user scans a bill which is converted into text and then sent as an email to an audit manager, the scanned copy of the bill is archived on the file server, an email alert is sent to an account manager to issue a check, and finally, all the above processes are logged in the system.

Workflows can be accessed at the front panel (also referred to as “control panel”) of a MFP. For example, a user can walk up to the device with their bill and place the bill on the scanner and click “A/C Payable” button from the control panel. This will initiate the workflow and the document will be scanned and passed along as per workflow rules.

However, existing MFPs do not allow users at a remote location to use workflows that reside in the MFPs. To enable remote users to access workflows, one option is to have a special workflow created for remote users such that the workflow is executed through some other medium instead of the front panel of the MFP. However, this option raises various issues including maintaining duplicate workflows, keeping them in synchronization, and keeping logs in one place.

Therefore, it is desirable to add new capabilities to MFPs and other devices that allow remote users to access workflows on these devices.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

In one aspect, there is a device having a scan capability. The device comprises a front panel having a first control associated with a process for a scanned document. The device further comprises an embedded web server adapted for connection to a remote user interface, wherein the remote user interface interacts with the embedded web server to provide a remote control panel. The remote control panel comprises a second control that permits a user to upload an electronic document to the device, and a third control corresponding to the first control so as to process the uploaded document according to the process associated with the first control.

In another aspect, there is a system for remotely accessing a device having a scan capability. The device comprises a front panel comprising a first control associated with a process for a scanned document, and an embedded web server. The system also comprises a remote user interface remotely connected to the embedded web server, wherein the remote user interface interacts with the embedded web server to provide a remote control panel. The remote control panel comprises a second control that permits a user to upload an electronic document to the device, and a third control corresponding to the first control so as to process the uploaded document according to the process associated with the first control.

In another aspect, there is a method of remotely accessing a device having a scan capability, the device comprising a front panel and an embedded web server. The method comprises remotely connecting to the device via the embedded web server, traversing a remote control panel provided by the embedded web server, uploading an electronic document to the device via the remote control panel, and selecting a first control on the remote control panel to process the uploaded document, wherein the front panel comprises a second control associated with a process for a scanned document and wherein the first control corresponds to the second control so as to process the uploaded document according the process associated with the second control.

In another aspect, there is a system for remotely accessing a device having a scan capability, the device comprising a front panel and an embedded web server. The system comprises means for remotely connecting to the device via the embedded web server, means for traversing a remote control panel provided by the embedded web server, means for uploading an electronic document to the device via the remote control panel, and means for selecting a first control on the remote control panel to process the uploaded document, wherein the front panel comprises a second control associated with a process for a scanned document and wherein the first control corresponds to the second control so as to process the uploaded document according the process associated with the second control.

### BRIEF DESCRIPTION OF THE DRAWINGS

FIG. 1 is an overview illustrating one embodiment of a system for remotely accessing a workflow at a MFP.

FIGS. 2A and 2B illustrate exemplary views of the front panel of a MFP as seen by the front panel user and as seen by the remote front panel user respectively.

FIG. 3 is a flowchart of one embodiment of a method of remotely accessing a workflow at a MFP.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details. For example, electrical components may be shown in block diagrams in order not to obscure certain aspects in unnecessary detail. In other instances, such components, other structures and techniques may be shown in detail to further explain certain aspects.

It is also noted that certain aspects may be described as a process, which is depicted as a flowchart, a flow diagram, a structure diagram, or a block diagram. Although a flowchart may describe the operations as a sequential process, many of the operations may be performed in parallel or concurrently and the process may be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The purpose of certain embodiments as will be described below is to provide a remote operation capability in a multi-function peripheral (MFP) and give a user the ability to remotely access workflows on the MFP. The MFP may include an embedded web server connected to a remote user interface via a network. The remote user interface interacts with the embedded web server to provide a remote control panel (also referred to as “remote front panel”) via which a user may traverse the menus of the front panel. To use a workflow on the MFP to process a document, a user may simply, via the remote control panel, upload an electronic document to the device and select a control associated with the workflow. The uploaded document will then be processed as per rules associated with the workflow. These embodiments are also applicable to other devices having a front panel, such as a printer, facsimile, scanner, or copy machine.

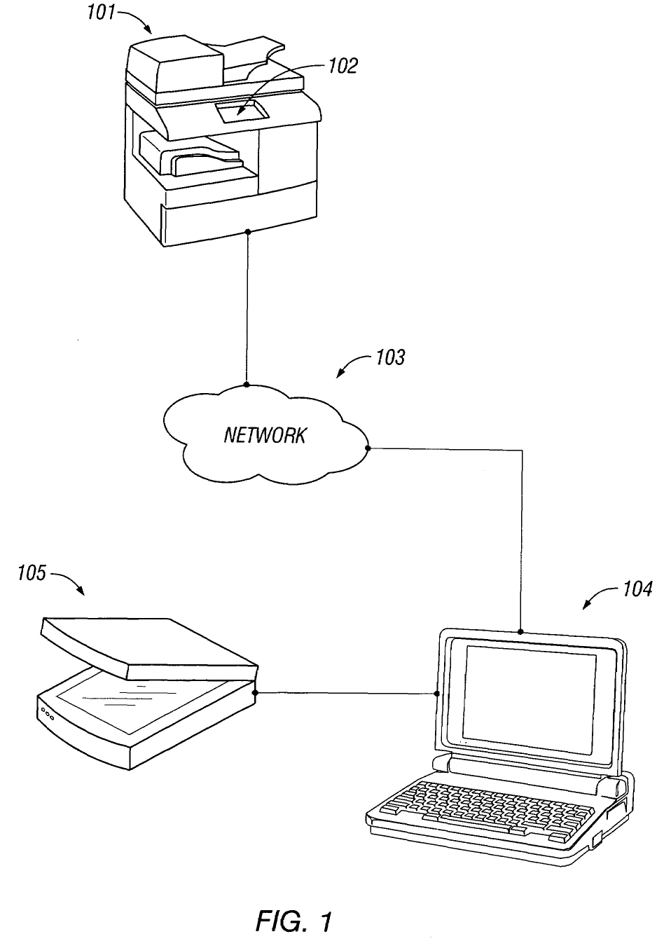

FIG. 1 is an overview illustrating one embodiment of a system for remotely accessing a workflow at a MFP. A MFP refers to an equipment connectable to a personal computer (PC) or network that handles two or more of the following functions: printing, emailing, copying or faxing. It is also called a multi-function product, a multi-function printer, a multi-function device, an All-in-One device, etc. Though a MFP is used as an example for illustration, the embodiments are applicable to other devices having a front panel such as a printer, facsimile, scanner, or copy machine.

A front panel 102 may be included in the MFP 101. A front panel may be included in various devices to provide a user interface to control and operate the devices. Via the front panel, a user may, for example, change and save settings at the device and access other functions provided. Typically, a front panel has a menu interface. The user may look at a menu, select one of the controls (such as a menu tab, a menu item, an icon or a button) on display, and go to the next screen associated with the selected control. A control may be selected when, for example, a user clicks on the control.

A remote user interface (also referred to as “terminal”) 104 is connected to the MFP 101 via a network 103. The network 103 may be wired or wireless. The network 103 may be a local area network (LAN), wide area network (WAN), or the Internet, for example. The remote user interface 104 may be any suitable device that provides a user interface and supports network connection, such as a personal computer and a personal digital assistant.

In the exemplary embodiment, the remote user interface 104 is connected to an embedded web server of the MFP 101. An embedded web server generally refers to a web server software embedded within a hardware device such as a print server. An embedded web server is widely used in a myriad of devices, because it allows access to the software via any Web browser, typically for configuring the device or obtaining reports.

The connection between the remote user interface and the embedded web server may be established, for example, when a user types in the IP address of the MFP 101 in a web browser. Once connected, the embedded web server causes a remote control panel to be displayed on the remote user interface 104 in, for example, a web browser. The remote control panel may have substantially the same functionality, and perhaps the same appearance, as the front panel 102. A user may be able to make a selection on the remote control panel to traverse the menus on the front panel 102. Changes made through the remote control panel are reflected in the front panel 102. Further detail on the remote control panel may be found in the above-cited U.S. patent application Ser. No. ______ (Attorney Docket No.: SAMINF.032A).

In one embodiment, the remote user interface 104 may need to have access to an electronic document in order to use a desired workflow at the MFP 101. The remote user interface 104 may include a storage device on which the electronic document is stored. The remote user interface may have access to the electronic document via the network 103 or a wired/wireless connection or communication link.

In one embodiment, the remote user interface 104 is connected to a scanning device 105. The scanning device 105 is a device that can scan a document, such as a MFP or a scanner. The scanning device 105 is located in close proximity to the remote user interface 104 such that a user of the remote user interface 104 may scan a hardcopy document at the scanning device 105 and access the scanned copy of the document promptly. The scanning device may be connected to the remote user interface 104 via the network 103 or a wired/wireless connection or communication link.

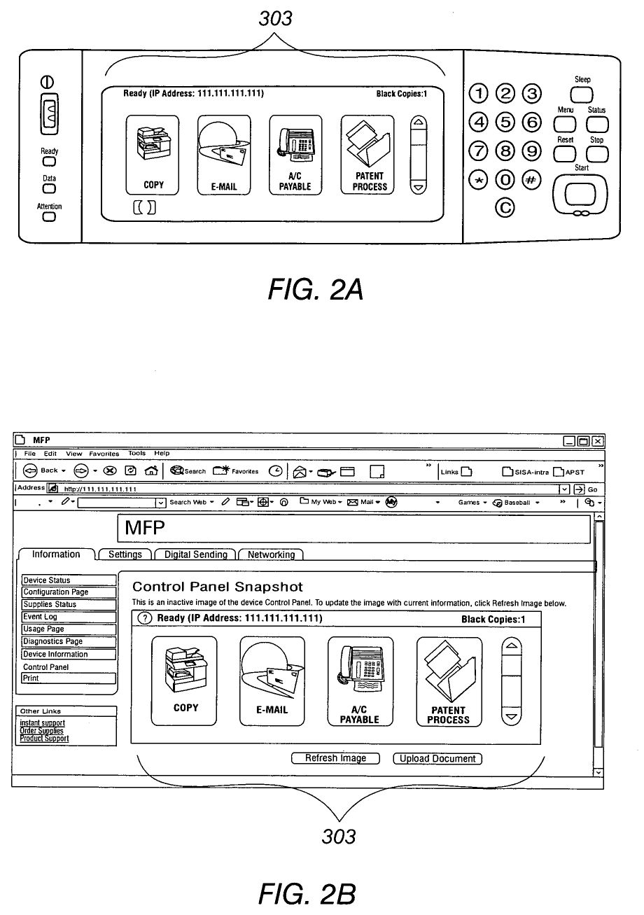

FIGS. 2A and 2B illustrate exemplary views of the front panel of a MFP as seen by the front panel user and as seen by the remote front panel user respectively. As shown in FIG. 2A, the front panel of the MFP 101 includes two workflows A/C Payable and Patent Process, each associated with a control. A workflow is initiated when a control associated with the workflow is selected via the front panel. Generally, a workflow at the front panel is suitable for a document that needs to be scanned. A user at the front panel can first put a hardcopy document on the scanner and then select the appropriate control, e.g., the menu tab, to use an automated workflow to process the scanned document.

A user may see a remote control panel of the MFP 101 through a web browser as shown in FIG. 2B, by, for example, navigating through the IP address of the device. The remote control panel displays the IP address, e.g., 111.111.111.111, in the middle of the screen. The remote control panel provides substantially the same display as the front panel. The remote control panel shows the two workflows A/C Payable and Patent Process. By selecting the menu tab associated with a workflow in the remote control panel, a user is able to initiate the workflow. Because a remote user is not physically at the device, he cannot scan a document to the workflow. Instead, the remote control panel provides a control, e.g., a button labeled “Upload Document,” to allow a user to upload an electronic document to the workflow at the MFP 101. When a remote user initiates the workflow, the uploaded document is to be processed per rules associated with the selected workflow.

As defined earlier, a workflow is a specialized sequence of tasks often used to process one or more documents. These tasks may be defined by, for example, a set of rules associated with the workflow. The workflow and the associated rules may be configurable via the front panel and the remote control panel. Changes made to the workflow and the associated rules may be saved at the MFP 101 and reflected in both the front panel and the remote control panel.

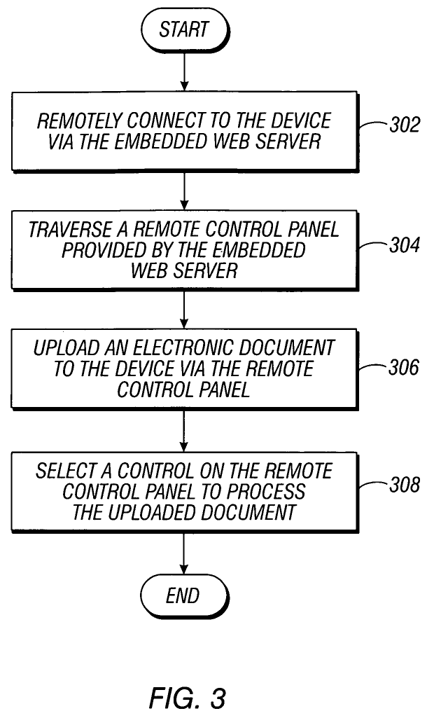

FIG. 3 is a flowchart of one embodiment of a method of remotely accessing a workflow at a MFP. The exemplary method may be performed on, for example, a system as described in FIG. 1. Depending on the embodiment, certain steps of the method may be removed, merged together, or rearranged in order. The general principle of the exemplary method will be described as below.

The method begins at a block 302, where a user connects a remote user interface to the embedded web server of the MFP. The connection may be established by, for example, typing a uniform resource locator (URL) in a web browser. In the example, the URL is “http://111.111.111.111” where 111.111.111.111 is the IP address of the device. Once the connection is established, a remote control panel is displayed in the web browser at the remote user interface 104.

Next at a block 304, the user traverses the remote control panel provided by the embedded web server to find a control associated with a desired workflow. The remote control panel provides substantially the same functionality as the front panel. The remote control panel may have substantially the same appearance as the front panel. In one embodiment, the remote control panel has substantially the same controls as the front panel. The user may traverse the menus and controls of the front panel via the remote control panel as if he is operating the front panel at the MFP.

Moving to a block 306, the user uploads an electronic document to the device via the remote control panel. For example, the user may use the button “Upload Document” in FIG. 2B to upload the document. Once the button is clicked, a new page may pop up and allow the user to browse and choose the document to be uploaded.

In one embodiment, a user may want to use the workflow to process a hardcopy document at hand. The user may put the hardcopy document on the scanning device 105 for scanning, send a scanned copy to the remote user interface 104, and then upload the scanned copy in the remote control panel 102. The scanning device 105 is located in close proximity to the remote user interface 104 such that a user of the remote user interface 104 may scan a hardcopy document at the scanning device 105 and access the scanned copy of the document promptly.

Lastly, at a block 308, the user selects a control associated with the desired workflow in the remote control panel to initiate the workflow. The user may select a control, for example, by using a mouse to click on the control. The MFP 101 then processes the uploaded document per rules of the desired workflow. For example, a copy of a scanned bill is transmitted to the MFP 101, where it is archived, logged and an alert is created and sent as an email. In the future, it can be printed and/or faxed.

It should be clear from the above description that a remote user now has access to the same workflows as a user at the device has. There is no need to maintain two separate processes/workflows. All the usage is tracked through only one system and there is no need for synchronization.

The foregoing embodiments may be applicable to various applications, as illustrated by two examples below. In a first example, a user in close proximity to a device wants to use a workflow but does not have hardcopy documents. The user has electronic documents that he wants to send to the workflow. Instead of walking to the device to trigger the workflow, the user will use the same method as above. The user will go to the web browser, point to the IP address of the device to get access to the remote control panel. Then the user will upload the document and initiate the workflow from the web browser.

In another example, there is a restriction to use only designated fax machines or MFPs in an office for security and/or tracking purposes. Remote users will be able to use the remote access method as described if the fax capability is part of the workflow. One of ordinary skill in the art will appreciate many other applications of embodiments disclosed herein and their variants.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather that by the foregoing description. All changes which come within the meaning and range of equivalency of the claims are to be embraced within their scope.

What is claimed is:

1. A device having a scan capability, comprising:
a front panel comprising a first control associated with a process for a scanned document; and
an embedded web server adapted for connection to a remote user interface, wherein the remote user interface interacts with the embedded web server to provide a remote control panel, wherein the remote control panel comprises:
a second control that permits a user to upload an electronic document to the device, and
a third control corresponding to the first control so as to process the uploaded document according to the process associated with the first control.

2. The device of claim 1, wherein the remote control panel and the front panel provide substantially the same functionality.

3. The device of claim 1, wherein the remote control panel and the front panel have substantially the same appearance.

4. The device of claim 1, wherein changes made via the remote control panel are reflected on the front panel of the device.

5. The device of claim 1, wherein the device is a multi-function peripheral (MFP).

6. The device of claim 1, wherein the process is configurable via the front panel and the remote control panel.

7. The device of claim 1, wherein the process for a scanned document is embodied as software executed by the device.

8. The device of claim 1, wherein the process is a workflow.

9. The device of claim 8, wherein a workflow comprises a sequence of tasks associated with storage or transmission of the scanned document or information relating to the scanned document.

10. A system for remotely accessing a device having a scan capability, comprising:
a device having scan capability, comprising:
a front panel comprising a first control associated with a process for a scanned document, and
an embedded web server, and
a remote user interface remotely connected to the embedded web server, wherein the remote user interface interacts with the embedded web server to provide a remote control panel, wherein the remote control panel comprising:
a second control that permits a user to upload an electronic document to the device, and
a third control corresponding to the first control so as to process the uploaded document according to the process associated with the first control.

11. The system of claim 10, further comprising another device having a scan capability connected to the remote user interface and located in physical proximity to the remote user interface, such that a user is able to scan a document at the other device and upload the scanned copy of the document from the remote control panel.

12. The system of claim 10, further comprising a storage device associated with the remote user interface, wherein a user is able to upload an electronic document stored on the storage device.

13. The system of claim 10, wherein the device is a multi-function peripheral (MFP).

14. The system of claim 1, wherein the process is a workflow.

15. A method of remotely accessing a device having a scan capability, the device comprising a front panel and an embedded web server, comprising:
connecting to the device via the embedded web server;
traversing a remote control panel provided by the embedded web server;
uploading an electronic document to the device via the remote control panel; and
selecting a first control on the remote control panel to process the uploaded document,
wherein the front panel comprises a second control associated with a process for a scanned document and wherein the first control corresponds to the second control so that the uploaded document is processed at the device according to selection of the second control.

16. The method of claim 15, further comprising scanning a document at a location proximate to the remote control panel, wherein the uploaded document is the scanned document.

17. The method of claim 15, wherein the connecting to the device comprises connecting to the device via the embedded web server from a remote location.

18. The method of claim 15, wherein the connecting to the device comprises connecting to the device via the embedded web server from a proximate location.

19. A system for remotely accessing a device having a scan capability, the device comprising a front panel and an embedded web server, comprising:
means for remotely connecting to the device via the embedded web server;
means for traversing a remote control panel provided by the embedded web server;
means for uploading an electronic document to the device via the remote control panel; and
means for selecting a first control on the remote control panel to process the uploaded document,
wherein the front panel comprises a second control associated with a process for a scanned document and wherein the first control corresponds to the second control so that the uploaded document is processed at the device according to selection of the second control.
